(19) United States
(12) Patent Application Publication
(10) Pub. No.: US 2007/0197282 A1
(43) Pub. Date: Aug. 23, 2007

(54) Betting terminal with watchdog

(75) Inventor: Martin Moshal, Queens Way Quay (GI)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Waterleaf Limited, Isle of Man (GB)

(21) Appl. No.: 10/557,271

(22) PCT Filed: May 20, 2004
(86) PCT No.: PCT/IB04/01635

§ 371 Date: Mar. 1, 2007

(30) Foreign Application Priority Data
May 21, 2003 (GB) 0311670.4

(51) Int. Cl. A63F 9/24; A63F 13/00

(52) U.S. Cl. 463/29

(57) ABSTRACT

A betting terminal comprises a gaming server that regulates the progress of any one of a number of different selectable games, a user access facility usable by a player to select any one of the games for play and to place a wager thereon, a communication network providing communication between the gaming server and the gaming server, a watchdog controller configurable to disable the user access facility for play upon the occurrence of a predetermined event, and a reset facility activatable to re-enable the user access facility for play. The predetermined event con be configured to be any one of the effluxion of a configurable period of time, the completion of a configurable number of turns of any of the different games, and the earlier of the effluxion of the configurable period of time and the completion of the configurable number of turns of any of the different games. The reset facility re-enables the user access facility for play upon entry of a unique authorisation code that is identical to a predetermined authorisation code.

### FIELD OF THE INVENTION

This invention relates to a betting terminal and, more particularly, to a betting terminal of a type that is commonly employed in betting shops, entertainment venues and the like. The invention extends to a method of operating of a betting terminal.

### BACKGROUND OF THE INVENTION

Betting terminals have become increasingly common in a number of different jurisdictions that have a regulated gambling industry.

Such a betting terminal has a player console that offers a player a menu of one or more games of chance that the player can select to play. Each game of chance has outcomes that are determined by random events, usually generated by means of a random number generator implemented in software. The software random number generator may be executed locally within the player console itself, or may be implemented externally in a gaming server to which the player console is linked by means of a communication network. In the latter topology, one or more separate player consoles may be connected to a single external gaming server by means of the communication network.

It is common for the player to play any of the games of chance by means of pre-purchased credit. For reasons of simplicity and convenience, it is customary for the player console to be equipped with a coin-receiving mechanism and a banknote reader that will allow the player to acquire credit in a simple manner without the necessity of using payment tokens such as credit cards, debit cards and the like. The player console may also be equipped with a printer that prints out an encoded voucher on demand when the player desires to terminate his playing session and to cash out any credit that he may have accumulated. The voucher may be redeemed for cash from an operator of the betting terminal.

The games of chance offered by the player console may offer jackpot prizes that can be won from time to time.

Such a betting terminal operates in an “always on” mode, in the sense that no player login or authentication process is required in order to play any of the games of chance. The player console may be located at a convenient location, such as a betting shop, an entertainment venue, or the like. The gaming server to which the player console is linked may also be located with the player console, or may be located remotely therefrom. Revenue derived from the betting terminal by an operator thereof may be shared with a supplier of the terminal or, alternatively, the operator may rent the betting terminal from the supplier thereof in exchange for regular payments. Other similar commercial arrangements are possible between the operator and the supplier of the betting terminal.

Those skilled in the art will appreciate that difficulties may arise from time to time causing the operator of the betting terminal to default on the commercial arrangements with the supplier. As far as the applicant is aware, there does not exist a betting terminal with a capacity to discourage default by the operator.

### OBJECT OF THE INVENTION

It is an object of this invention to provide to provide a betting terminal and a method of operation thereof that will, at least partially, alleviate the abovementioned difficulties and disadvantages.

### SUMMARY OF THE INVENTION

In accordance with this invention there is provided a betting terminal, comprising: a gaming server operable under program control to regulate the progress of any one of a number of different selectable games;

a user access facility usable by a player to select any one of a number of different games for play and to place a wager thereon, the user access facility being communicable with the gaming server by means of a communication network;

a watchdog controller configurable to disable the user access facility for play upon the occurrence of a predetermined event; and

a reset facility activatable to re-enable the user access facility for play.

Further features of the invention provide for the watchdog controller to disable the user access facility for play by suspending communication between the user access facility and the gaming server, for the reset facility to re-enable the user access facility for play by re-establishing communication between the user access facility and the gaming server, for the predetermined event to be the effluxion of a configurable period of time, alternatively for the predetermined event to be the completion of a configurable number of turns of any of the different selectable games, further alternatively for the predetermined event to be the earlier of the effluxion of the configurable period of time and the completion of the configurable number of turns of any of the different selectable games.

Still further features of the invention provide for the reset facility to be activatable to restore the communication between the user access facility and the gaming server upon entry of a unique authorisation code, for the unique authorisation code to be enterable by means of the user access facility, for the unique authorisation code to be generated by means of a code generation means remote from the betting terminal, for the reset facility to be a software program arranged to compare the entered authorisation code with a predetermined authorisation code, and for the reset facility to restore communication between the user access facility and the gaming server when the entered authorisation code and the predetermined authorisation code are identical.

Yet further features of the invention provide for the games to be casino games, for the communication network to be an open communication network, preferably the Internet, and for the user access facility to be a computer workstation connectable to the World Wide Web of the Internet.

The invention extends to a method of operating a betting terminal, comprising the steps of:

operating a gaming server under program control to regulate the progress of any one of a number of different selectable games;

selecting, by means of a user access facility, any one of the number of different games for play and placing a wager thereon, the user access facility being communicable with the gaming server;

disabling the user access facility for play upon the occurrence of a predetermined event; and

selectively restoring the user access facility for play.

There is further provided for disabling the user access facility for play by suspending communication between the user access facility and the gaming server, for restoring the user access facility for play by re-establishing communication between the user access facility and the gaming server, for the predetermined event to be the effluxion of a configurable period of time, alternatively for the predetermined event to be the completion of a configurable number of turns of any of the different selectable games, further alternatively for the predetermined event to be the earlier of the effluxion of the configured period of time and the completion of the configured number of turns of any of the different selectable games.

There is still further provided for selectively restoring communication between the user access facility and the gaming server upon entry of a unique authorisation code, for entering the unique authorisation code by means of the user access facility, for generating the unique authorisation code remotely from the betting terminal, for comparing the entered authorisation code with a predetermined authorisation code, and for restoring communication between the user access facility and the gaming server when the entered authorisation code and the predetermined authorisation code are identical.

### BRIEF DESCRIPTION OF THE DRAWINGS

A preferred embodiment of the invention is described below, by way of example only, and with reference to the abovementioned drawings, in which:

FIG. 1 is a functional representation of a betting terminal according to the invention.

### DETAILED DESCRIPTION OF THE INVENTION

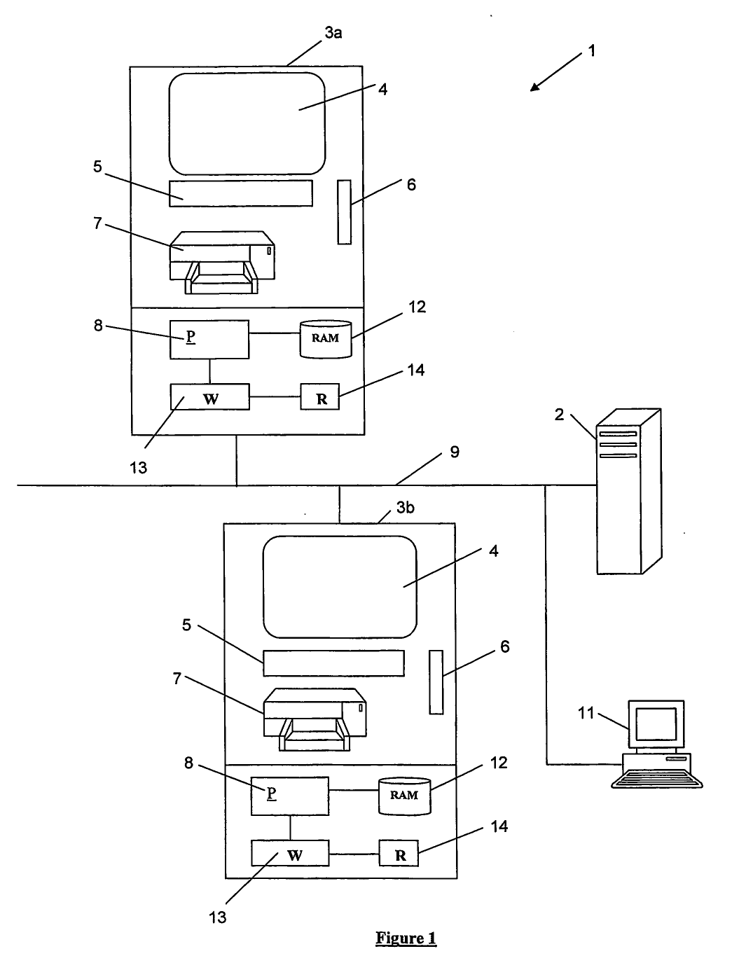

Referring to FIG. 1, a betting terminal is indicated generally by reference numeral (1).

The betting terminal (1) includes a gaming server (2) and two user access facilities (3a and 3b) in the form of two player consoles, each including a touch screen (4), a banknote reader (5), a coin receiving mechanism (6) such as a coin slot, and a thermal printer (7). Each player console also includes an Internet-enabled processor (8) which is in communication with the gaming server (2) by means of a communication network (9) that is, in this embodiment, the Internet.

The player consoles (3a and 3b) are located remotely from the gaming server (2). Each player console (3) is usable by a player to play any one of a number of different video games that are available for play. A menu of available games is presented to the player on the touch screen (4) and the player is able to select any one of the games in the menu for play by touching corresponding icons (not shown) displayed on the screen in a manner that is well known in the art.

The Internet-enabled processor (8) is a conventional personal computer operating under a Windows 2000 operating system, which is well known and commercially available from the Microsoft Corporation of Seattle, Wash., USA. The Internet-enabled processor (8) and the gaming server (2) execute different components of any available game that is selected for play by the player. Each game consists of a client process that is executed in the processor (8) and a server process that is executed in the gaming server (2). The client process of a selected game simulates the progress of the game on the touch screen (4), while the server process generates, upon request of the of the client process, one or more random events that determine an outcome or outcomes of a turn of the game. The client component obtains the result of the random event and utilises the result to display a corresponding outcome of the game to the player in an intelligible manner by means of the simulation on the touch screen (4).

Each one of the available games is playable by the player against the consumption of credit. The player may insert one or more banknotes into the banknote reader (5) and coins into the coin slot (6) in order to procure credit to play any of the games, without the need to use payment tokens such as debit cards, credit cards or the like. A player's credit balance is displayed on the touch screen (4) at all times. The player utilises his credit to place a wager on every turn of the games that he selects for play. The outcome of any wager is either an unsuccessful outcome in which the player's wager is forfeited to an operator of the betting terminal (1), or a successful outcome in which the player's wager is paid out at predetermined odds.

The betting terminal (1) also includes a code generation means (11) that consists of a processor capable of executing a code generation software program. The code generation means (11) and the processor (8) are capable of communicating by means of the communication network (9). Execution of the code generation software program causes a single, unique authorisation code to be generated. This unique authorisation code can be transmitted to the processor (8) along the communication network (9).

The betting terminal (1) includes, further, a watchdog controller (13) associated with each player console. The watchdog controller (13) is a watchdog software program that is executable in the processor (8) of each player console. The watchdog software program (13) is configurable to disable the player console for play by suspending communication between the processor (8) and the gaming server (2) when certain conditions obtain. In particular, the conditions relate to the occurrence of a predetermined event, such as the effluxion of a selectable predetermined period of time. When the predetermined event occurs, the watchdog controller (13) effectively decouples the processor (8) from the gaming server (2), thus rendering the player console inoperative for further play by the player.

When the predetermined event occurs, the watchdog controller (13) also transmits a control signal to the code generation means (11) causing a unique authorisation code to be generated and returned to the processor (8) along the communication (9) for storage in the non-volatile memory (12).

While communication between the processor (8) and the gaming server (2) are suspended, the watchdog controller (13) monitors input from the touch screen (4) to detect input of an authorisation code thereon. When input of an authorisation code is detected, a reset facility (14) in the form of a comparator compares the inputted authorisation code against the unique authorisation code stored in the non-volatile memory (12). If the inputted and stored authorisation codes match, the reset facility (14) re-enables the player console for play by re-establishing communication between the processor (8) and the gaming server (2).

In use, upon the occurrence of the predetermined event, the player console is disabled for play and can be re-enabled for play through the use of a valid authorisation code. It will be appreciated by those skilled in the art that the valid authorisation code must be under the control of a supplier of the betting terminal (1) and should be released to an operator of the betting terminal only upon the latter's compliance with all commercial arrangements required by the supplier.

Numerous modifications are possible to this embodiment without departing from the scope of the invention. In particular, the predetermined code generated by the code generation means (11) may be transmitted to the processor (8) and stored in the non-volatile memory (12) in an encrypted form. Further, the predetermined event which triggers disablement of the player console for play may be the completion of a predetermined number of turns of any of the different games played by the player or, alternatively, the earlier of the effluxion of a predetermined period of time and the completion of the predetermined number of turns of any of the different games. Still further, occurrence of the predetermined event may be utilised to simultaneously disable all of the player consoles for play, and inputting of the authorised code may simultaneously re-enable all of the player consoles connected to the gaming server. Yet further, the betting terminal (1) may include a further watchdog resetting facility that allows the watchdog controller (13) to be re-set before the occurrence of the predetermined event and subsequent disablement of the player console for play, thereby maintaining continuity of operation.

The invention therefore provides a betting terminal (1) with a configurable watchdog facility that can disable the betting terminal for play under certain conditions.

1-18. (canceled)

19. A betting terminal, comprising:
gaming server operable under program control to regulate the progress of any one of a number of different selectable games;
a user access facility usable by a player to select any one of a number of different selectable games for play and to place a wager thereon, the user access facility being communicable with the gaming server by means of a communication network;
a watchdog controller configurable to disable the user access facility for play upon the occurrence of a predetermined event by suspending communication between the user access facility and the gaming server; and
a reset facility activatable to re-enable the user access facility for play by re-establishing communication between the user access facility and the gaming server upon entry of a unique authorisation code.

20. A betting terminal as claimed in claim 19 in which the predetermined event is any one of the effluxion of a configurable period of time, the completion of a configurable number of turns of any of the different selectable games, and the earlier of the effluxion of the configurable period of time and the completion of the configurable number of turns of any of the different selectable games.

21. A betting terminal as claimed in claim 19 in which the unique authorisation code is enterable by means of the user access facility.

22. A betting terminal as claimed in claim 21 in which the unique authorisation code is generated by means of a code generation means remote from the betting terminal.

23. A betting terminal as claimed in claim 19 in which the reset facility is arranged to compare the authorisation code with a predetermined authorisation code and to restore communication between the user access facility and the gaming server when the entered authorisation code and the predetermined authorisation code are identical.

24. A betting terminal as claimed in claim 19 in which the number of different selectable games are casino games.

25. A betting terminal as claimed in claim 19 in which the open communication network is the Internet.

26. A betting terminal as claimed in claim 25 in which the user access facility is a computer workstation connectable to the World Wide Web of the Internet.

27. A method of operating a betting terminal, comprising the steps of:
executing a program in a gaming server to regulate the progress of any one of a number of different selectable games;
selecting, by means of a user access facility, any one of the number of different games for play and placing a wager thereon, the user access facility being communicable with the gaming server;
disabling the user access facility for play upon the occurrence of a predetermined event by suspending communication between the user access facility and the gaming server; and
selectively re-enabling the user access facility for play by re-establishing communication between the user access facility and the gaming server upon entry of a unique authorisation code.

28. A method as claimed in claim 27 in which the predetermined event is any one of the effluxion of a configurable period of time, the completion of a configurable number of turns of any of the different selectable games, and the earlier of the effluxion of the configured period of time and the completion of the configured number of turns of any of the different selectable games.

29. A method as claimed in claim 27 in which the unique authorisation code is entered by means of the user access facility.

30. A method as claimed in claim 29 that includes the step of generating the unique authorisation code remotely from the betting terminal.

31. A method as claimed in claim 27 in which the entered authorisation code is compared with a predetermined authorisation code, and communication between the user access facility and the gaming server is restored when the entered authorisation code and the predetermined authorisation code are identical.
